(19) United States
(12) Patent Application Publication
(10) Pub. No.: US 2003/0070818 A1
(43) Pub. Date: Apr. 17, 2003

(54) Personal search rope bag

(76) Inventor: John C. Hicks, Virginia Beach, VA (US)

Correspondence Address: Bradley D. Goldizen, Esq., c/o Pender & Coward, P.C., Greenwich Centre, Suite 400, 192 Ballard Court, Virginia Beach, VA, 23462, US

(21) Appl. No.: 09/977,116

(22) Filed: Oct. 15, 2001

(51) Int. Cl. A62C 2/00

(52) U.S. Cl. 169/43; 224/191; 224/235; 224/242; 224/904; 116/200; 182/18; 182/100

(57) ABSTRACT

The invention includes a personal search rope bag for use in facilitating firefighters in conducting reconnoiter and rescue operations in a burning structure. The personal search rope bag is lightweight, durable and user friendly. A method of conducting a search using the personal search rope bag is also disclosed.

### BACKGROUND OF THE INVENTION

The present invention relates to firefighting devices and methods. When firefighters arrive at the scene of a fire, it is typically necessary for them to enter a building to knock down a fire or search and rescue people. Ordinarily several firefighters enter the building by either following or carrying a single hose line through an entrance. Depending upon the nature of the fire, some of the firefighters fan out into rooms on either sides of the hose line to search for individuals in need of assistance.

As the building bums, smoke accumulates near the ceiling of each room and significantly reduces visibility. A firefighter who leaves the hose line to fan out into a room to search for individuals in need of assistance runs the risk of becoming disoriented and lost. Further, it is sometimes difficult for a firefighter to carry a victim from an unfamiliar building during a fire. Precious lifesaving seconds may be wasted if the firefighter becomes disoriented and cannot readily egress from the burning structure.

### BRIEF SUMMARY OF THE INVENTION

The present invention is a personal search rope bag that allows firefighters to more safely search locations distant from a hose line or mainline search rope. The personal search rope bag advantageously aids a disorientated firefighter in returning to a hose line and thereby exiting a burning building. The invention also allows a trapped firefighter to maintain contact with a hose line or other firefighters while trying to find a way out of a structure. Additionally, if a firefighter becomes trapped away from the hose line, other firefighters can search for and find him by following the rope from his personal search rope bag. Further, if several firefighters become trapped in a room, they can link together the rope from each firefighter's personal search rope bag to simultaneously search out exits in various directions. Lastly, the invention may be readily jettisoned should the rope become entangled or ensnared in an obstacle or debris.

It is an object of the invention to reduce risks to firefighters that are associated with search and rescue operations distant from a hose line or mainline search rope.

It is a further object of the invention to provide an improved method of searching and recovering individuals in need of assistance in a burning building.

It is another object of the invention to provide a device that aids firefighters in retrieving and recovering injured firefighters who are distant of a hose line in a burning building.

It is an additional object of the invention to provide a device that is economically expendable and very durable. When properly used, this invention will save lives.

### BRIEF DESCRIPTION OF THE DRAWINGS

FIG. 1 is a front view of a personal search rope bag.

FIG. 2 is an inverted front view of the personal search rope bag.

FIG. 3 is a top view of the personal search rope bag.

FIG. 4 is an inverted front view of the personal search rope bag illustrating the retaining strap and the belt strap.

### DETAILED DESCRIPTION OF THE INVENTION

The following is the preferred embodiment or best mode for carrying out the invention. It should be noted that this invention is not limited by the discussion of the preferred embodiment. For example, various fastening means such as Velcro® strips and snap fasteners or other such fasteners may be substituted for one another without deviating from the spirit of this invention.

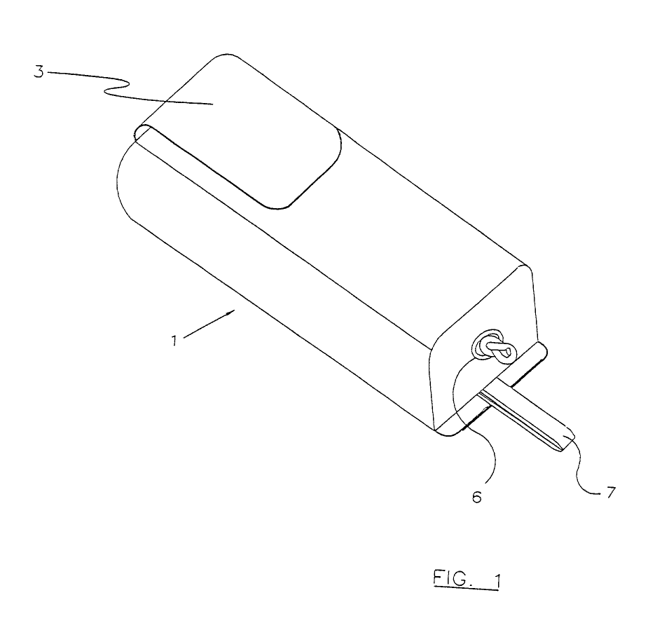

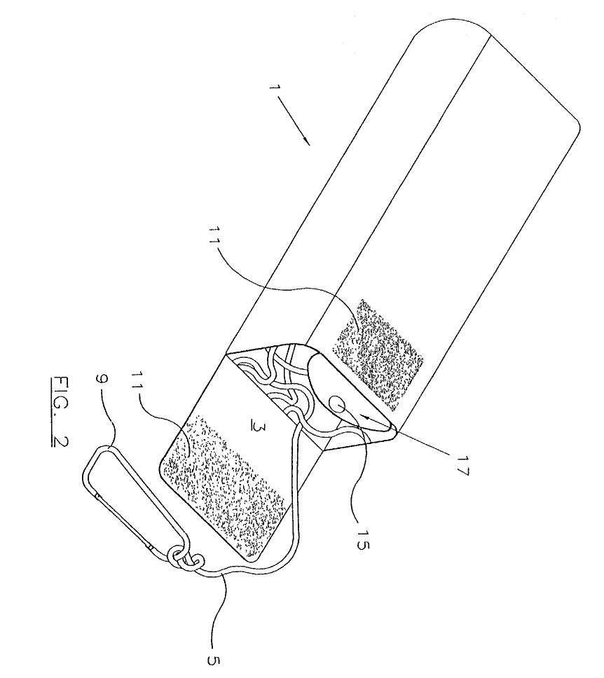

FIG. 1 depicts a front view of a personal search rope bag 1. A flap 3 is shown closed. The flap 3 secures a carabineer 9 shown in FIG. 2. The carabineer is also known as a D-ring. One end of the rope 5 is passed through a grommet 6 and knotted to create knot 4. The working end of the rope is fastened to the D-ring 9. A retaining strap 7 is shown beneath the knotted end of the rope 5.

In the preferred embodiment, the bag 1 is seven inches long, three inches wide, and two inches thick. The bag 1 has two ends; one being open; and, the other being closed. A grommet is fixed at the closed end of the bag 1.

FIG. 2 shows an inverted view of the personal search rope bag 1. Releasable fastening strips 11 are affixed to the flap 3 and personal search rope bag 1 as shown. D-ring 9 is attached to the working end of rope 5. D-ring pocket 17 accommodates D-ring 9 when flap 3 is closed. A snap fastener 15 hold the front and back sides of bag 1 together so that the rope plays out in an orderly fashion.

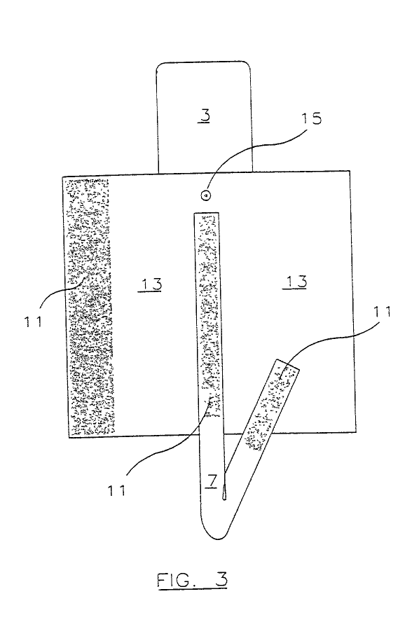

In FIG. 3, the retaining strap 7 comprises two mating releasable fastening strips 11. In the preferred embodiment, the retaining strap 7 is one inch wide by nine inches long. The retaining strap 7 is of double thickness with a two-inch long piece of mating releasable fastening strip 11 on an end. The other end of the retaining strip is permanently affixed to the bag 1. The retaining strap 7 is typically used to secure the personal search rope bag 1 to the waist strap of a Self-Contained Breathing Apparatus (SCBA). The retaining strap 7 should be secured to the SCBA by wrapping it around the shoulder strap of the SCBA at the point where it connects to the waist strap of the SCBA. The retaining strap 7 thereby prevents the personal search rope bag 1 from falling off of the waist strap of the SCBA when the waist strap is unbuckled. If the strap 7 is not used it should be secured inside the belt strap 13 to prevent the strap 7 from becoming entangled in building rubble or obstacles.

The belt strap 13 allows the personal search rope bag to be attached to a variety of fire gear applications. It is adjustable to fit the waist belt as well as both upper and lower shoulder straps of an SCBA. The mating releasable fastening strips allow the personal search rope bag 1 to be placed on straps that are fastened at both ends. The mating releasable fastening strips allow for the quick removal of the personal search rope bag 1. Without disconnecting the straps of the SCBA, the search rope bag 1 can be removed quickly from the firefighter if the personal search rope bag 1 or rope 5 is entangled in an obstacle or rubble.

FIG. 3 also depicts the exterior side of a snap fastener 15 at the open end of the rope bag 1. The snap fastener 15 may be constructed of stainless steel. The snap fastener 15 secures the front of the rope department to the rear of the rope department. The snap fastener 15 keeps the bulk of the rope 5 from falling out and possibly becoming entangled. The snap fastener 15 allows the rope 5 to play out smoothly on either side of the snap fastener 15.

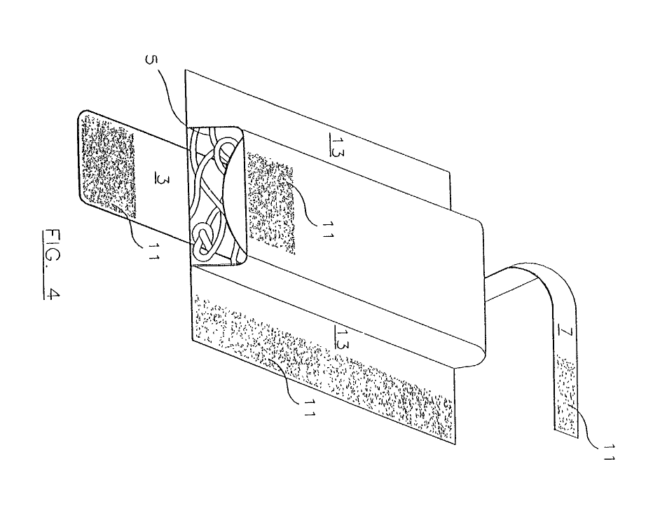

FIG. 4 depicts an inverted view of the personal search rope bag 1. In this figure the D-ring 9 is stowed in the D-ring pocket 17. The flap for covering the D-ring 3 is shown in an opened position thereby allowing access to the D-ring 9. The rope 5 is stowed in the rope compartment. In the preferred embodiment, the rope 5 is forty feet long and is typically 5 millimeters in diameter. The rope 5 is simply stuffed into the rope compartment. The rope 5 includes a knot on either side of the grommet. The knot on the inside prevents the rope 5 from falling out through the grommet. The knot on the outside secures the rope 5 to the personal search rope bag 1.

In the preferred embodiment, the D-ring 9 is of an aluminum non-locking utility grade. The working end of the rope 5 is secured to the D-ring 9. The D-ring is housed in the D-ring pocket 17 at the open end of the personal search rope bag 1. When the flap for covering the D-ring 3 is opened, the D-ring is easily accessible. When the D-ring is removed from D-ring pocket 17 and attached to an anchor point such as a hose line or main line search rope, it plays out of the personal search rope bag as the firefighter moves away from the anchor point. The flap 3 may be left open when the rope 5 is being used. It should be noted that the personal search rope bag 1 may be produced without the D-ring pocket 17. Additionally, the rope bag 1 and the rope 5 may be constructed of fire retardant materials. The rope may also be substituted with a belt or other such material. If a belt is used to couple the firefighter with the hose line, then the grommet may be substituted with another means for securing the belt to the bag.

It is to be understood that the invention is not limited to the exact construction illustrated and described above, but that various changes and modifications may be made without departing from the spirit and the scope of the invention as defined in the following claims.

1. A device for conducting reconnoiter and rescue operations in a darkened or burning structure, comprising:
a rope for coupling a firefighter with a hose line or main line search rope;
a bag for storing said rope; and,
an attachment means for attaching said bag onto a firefighter's equipment.

2. The device claim 1, further comprising a grommet affixed to said bag and having an end of the rope passed therethrough.

3. The device of claim 3, wherein said rope comprises a knot on either side of the grommet.

4. The device of claim 1, further comprising a quick connection means affixed at an end of the rope.

5. The device of claim 4, further comprising a pocket for removably containing said quick connection means.

6. The device of claim 5, further comprising a flap for closing said pocket.

7. The device of claim 1, further comprising a means for aiding the rope in playing out from the bag properly.

8. The device of claim 7 wherein said means for aiding the rope in playing out from the bag properly comprises a snap fastener.

9. The device of claim 3 wherein said quick connection means further comprises a carabineer.

10. A device for assisting firemen in fighting fires, comprising:
means for coupling a firefighter with a hose line or main line search rope;
means for storing said means for coupling said firefighter with the hose line or main line search rope; and
means for attaching said means for storing said means for coupling said firefighter with the hose line or main line search rope onto a firefighter's equipment.

11. The device of claim 10 further comprising means for securing said means for coupling the firefighter with the hose line to the means for storing said means for coupling the firefighter with the hose line or main line search rope.

12. The device of claim 11 wherein said means for securing said means for coupling the firefighter with the hose line or main line search rope to the means for storing said means for coupling the firefighter with the hose line or main line search rope is a grommet.

13. The device of claim 10 wherein said means for coupling the firefighter with a hose line main line search rope is a rope.

14. The device of claim 10 wherein said means for storing said means for coupling the firefighter to the hose line or main line search rope is a bag.

15. The device of claim 10 wherein said means for attaching said means for storing said means for coupling said firefighter with the hose line or main line search rope onto a firefighter's equipment is a belt strap.

16. The device of claim 13 wherein said rope is comprised of a flame-retardant material.

17. The device of claim 14 wherein said bag is comprised of a flame-retardant material.

18. The device of claim 10 further comprising a quick connection means affixed at an end of the means for coupling the firefighter with the hose line or main line search rope.

19. The device of claim 18 further comprising a means for removably securing the quick connection means.

20. A method of conducting reconnoitering and rescue operations, comprising:
attaching a line to a hose line or main line search rope
fanning out in the dwelling
retracing steps by orientating oneself by following the line.
